(19) United States
(12) Patent Application Publication
(10) Pub. No.: US 2013/0171976 A1
(43) Pub. Date: Jul. 4, 2013

(54) METHOD FOR PERFORMING MESSAGE CONTROL THROUGH A MULTIMEDIA PLAYER, AND ASSOCIATED APPARATUS

(71) Applicant: Heming Zhang, Hefei (CN)

(72) Inventor: Heming Zhang, Hefei (CN)

(21) Appl. No.: 13/390,933

(22) PCT Filed: Jan. 4, 2012
(86) PCT No.: PCT/CN2012/070001

§ 371 Date: Feb. 16, 2012

(51) Int. Cl. H04W 4/12

(52) U.S. Cl. 455/414.1

(57) ABSTRACT

A method for performing message control through a multimedia player includes: detecting whether a mobile phone associated to the multimedia player sends information indicating existence of at least one incoming message; and when it is detected that the mobile phone associated to the multimedia player sends the information indicating the existence of the at least one incoming message, triggering the multimedia player to provide a user with a user interface, allowing the user to read the incoming message through the multimedia player. An associated apparatus is also provided. For example, the apparatus may include a portion of the multimedia player, such as a control circuit of the multimedia player. In another example, the apparatus may include the whole of the multimedia player. In particular, the multimedia player can be one or a combination of an optical disc player, a set top box (STB), a television (TV), and/or a TV receiver.

### TECHNICAL FIELD

The present invention relates to control over messages received/sent by a mobile phone, and more particularly, to a method for performing message control through a multimedia player, and to an associated apparatus.

### BACKGROUND

Mobile phones have become a must for many users since there are many additional services provided through the mobile phones. For a user who owns a high end mobile phone, and more particularly, a multifunctional portable electronic device equipped with telecommunication functionality, such as a multifunctional mobile phone or a multifunctional personal digital assistant (PDA) equipped with telecommunication functionality, he/she may have lots of things to do by using the multifunctional portable electronic device. However, it seems there is a basic problem that the user may not (and more particularly, cannot) do these things in a situation where the multifunctional portable electronic device (e.g. the multifunctional mobile phone or the multifunctional PDA) is not on hand.

For example, in a situation where the user is lying on a soft sofa/bed to take a rest in an air conditioned living room/bedroom, with the multifunctional portable electronic device being put in another room, when there is an incoming message received by the multifunctional portable electronic device, the user cannot read the incoming message unless he/she leaves the comfortable environment to take the multifunctional portable electronic device. In another example, in a situation where the user is watching his/her favorite television (TV) program, surrounded by family, with the multifunctional portable electronic device being put somewhere at home, it seems unlikely that the user can read or reply to any message in time unless he/she leaves the comfortable environment to find out the multifunctional portable electronic device.

According to the above descriptions, the user can do nothing with incoming messages in a situation where the multifunctional portable electronic device is not on hand. Thus, a novel method is required for preventing any incoming message from being missed by the user in such a situation.

### SUMMARY

It is therefore an objective of the claimed invention to provide a method for performing message control through a multimedia player, and to provide an associated apparatus, in order to solve the problem mentioned above.

It is another objective of the claimed invention to provide a method for performing message control through a multimedia player, and to provide an associated apparatus, in order to server a user well. As a result of applying the method, the user can utilize the multimedia player to read or reply to one or more messages in time, having no need to find his/her mobile phone or leave a comfortable environment.

An exemplary embodiment of a method for performing message control through a multimedia player comprises: detecting whether a mobile phone associated to the multimedia player sends information indicating existence of at least one incoming message; and when it is detected that the mobile phone associated to the multimedia player sends the information indicating the existence of the at least one incoming message, triggering the multimedia player to provide a user with a user interface, allowing the user to read the incoming message through the multimedia player. In particular, the step of triggering the multimedia player to provide the user with the user interface further comprises: when it is detected that the mobile phone associated to the multimedia player sends the information indicating the existence of the at least one incoming message, triggering the multimedia player to provide the user with the user interface, allowing the user to reply to the incoming message through the multimedia player.

An exemplary embodiment of an associated apparatus for performing message control through a multimedia player comprises a control circuit arranged to control operations of the multimedia player, wherein the processing circuit comprises a detection module and a processing module. The detection module is arranged to detect whether a mobile phone associated to the multimedia player sends information indicating existence of at least one incoming message. In addition, when it is detected that the mobile phone associated to the multimedia player sends the information indicating the existence of the at least one incoming message, the processing module triggers the multimedia player to provide a user with a user interface, allowing the user to read the incoming message through the multimedia player. In particular, when it is detected that the mobile phone associated to the multimedia player sends the information indicating the existence of the at least one incoming message, the processing module triggers the multimedia player to provide the user with the user interface, allowing the user to reply to the incoming message through the multimedia player. For example, the apparatus may comprise at least one portion (e.g. a portion or all) of the multimedia player. In some embodiments, the multimedia player can be one or a combination of an optical disc player, a set top box (STB), a television (TV), and/or a TV receiver.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1A is a diagram of an apparatus for performing message control through a multimedia player according to a first embodiment of the present invention.

FIGS. 1B-1C respectively illustrate some implementation details involved with the apparatus shown in FIG. 1A according to different embodiments of the present invention.

FIG. 1D illustrates an exemplary mobile phone whose message input/output can be controlled through the apparatus shown in FIG. 1A according to an embodiment of the present invention.

FIG. 2 is a flowchart of a method for performing message control through a multimedia player according to an embodiment of the present invention.

FIGS. 3A-3C respectively illustrate some implementation details involved with the method shown in FIG. 2 according to an embodiment of the present invention.

FIG. 4 is a diagram of an apparatus for performing message control through a multimedia player according to a second embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

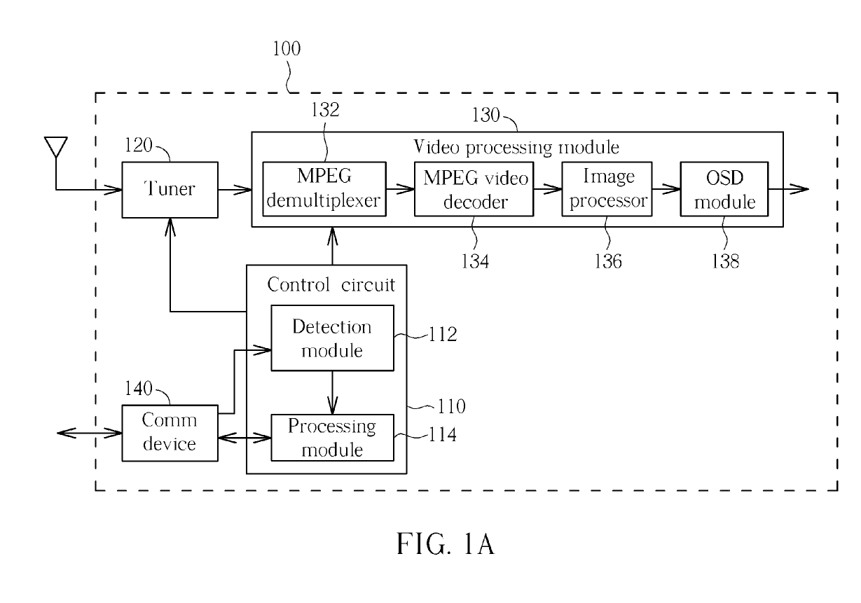

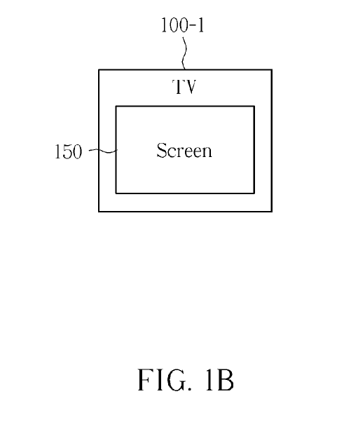

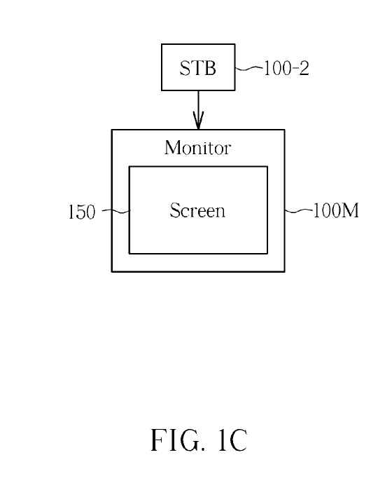

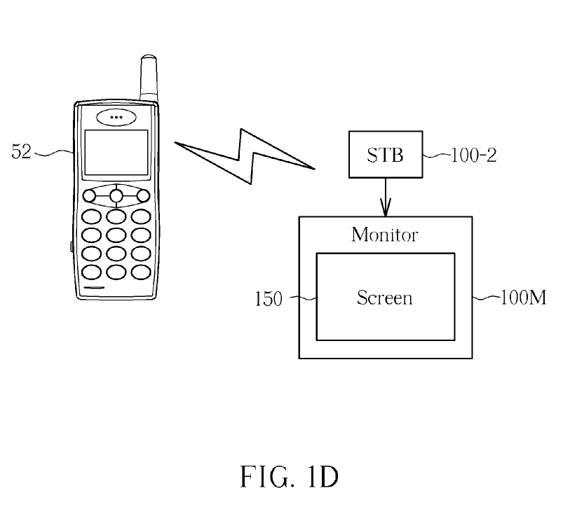

Please refer to FIG. 1A, which illustrates a diagram of an apparatus 100 for performing message control (e.g. message control regarding reading messages and/or replying to messages) through a multimedia player according to a first embodiment of the present invention. The apparatus 100 comprises a control circuit 110 arranged to control operations of the multimedia player, where the control circuit 110 comprises a detection module 112 and a processing module 114. In particular, the apparatus 100 of this embodiment may further comprise a tuner 120, a video processing module 130, and at least one communication device 140 (labeled “Comm device” in FIG. 1A). The tuner 120 is arranged to select one of a plurality of channels, and the video processing module 130 is arranged to perform video processing, while the communication device 140 can be utilized for performing communication operations, and more particularly, for accessing information from outside the multimedia player. For example, the tuner 120 can be a digital tuner and the video processing module 130 can be a digital processing module implemented with digital signal processing (DSP) technology. In another example, the tuner 120 can be an analog tuner and the video processing module 130 can be a signal processing module.

According to a special case of this embodiment, in a situation where the tuner 120 is a digital tuner, the video processing module 130 can be a video processing circuit comprising a Moving Picture Experts Group (MPEG) demultiplexer 132, an MPEG video decoder 134, and an image processor 136 (which are illustrated as an example of the architecture of the video processing module 130 shown in FIG. 1A, for better comprehension). The MPEG demultiplexer 132 is arranged to demultiplex video content and audio content of a program on the channel selected by the tuner 120 such as the digital tuner. In addition, the MPEG video decoder 134 is arranged to decode the video content demultiplexed by the MPEG demultiplexer 132, and more particularly, to perform MPEG-decoding on the video content. Additionally, the image processor 136 may further perform image processing on the decoded video content to be displayed. This is for illustrative purposes only, and is not meant to be a limitation of the present invention. In a situation where the tuner 120 is an analog tuner, the video processing module 130 may comprise some components arranged to perform signal processing, where implementing the MPEG demultiplexer 132, the MPEG video decoder 134, and the image processor 136 mentioned above within the video processing module 130 is not required. Please note that, no matter whether the tuner 120 is a digital tuner or an analog tuner, the video processing module 130 may further comprise an on screen display (OSD) module 138 arranged to perform OSD operations under control of the control circuit 110, in order to mix OSD information into the video content to be displayed. In addition, according to different variations of this embodiment, a display module can be integrated into the apparatus 100.

According to the embodiment shown in FIG. 1A, the detection module 112 is arranged to detect whether a mobile phone associated to the multimedia player sends information indicating existence of at least one incoming message such as one or more messages provided through Short Message Service (SMS). In addition, when it is detected that the mobile phone associated to the multimedia player sends the information indicating the existence of the at least one incoming message, the processing module 114 triggers the multimedia player to provide a user with a user interface, allowing the user to read the incoming message through the multimedia player. According to this embodiment, reading the incoming message is not the only service provided through the user interface. More specifically, when it is detected that the mobile phone associated to the multimedia player sends the information indicating the existence of the aforementioned at least one incoming message, the processing module 114 triggers the multimedia player to provide the user with the user interface, allowing the user to reply to the incoming message through the multimedia player.

In practice, the apparatus 100 (and more particularly, the control circuit 110) may comprise at least one storage unit (not shown in FIG. 1A, for brevity) for queuing messages. For example, the aforementioned at least one storage unit can be arranged to temporarily store the aforementioned at least one incoming message. In another example, the aforementioned at least one storage unit can be arranged to temporarily store the content of a message that the user is going to send through the multimedia player in reply to the incoming message. According to a variation of this embodiment, when needed, the user can utilize the multimedia player to search for a person in a contact list of the mobile phone, in order to find the contact information of the person, where the aforementioned at least one storage unit can be arranged to temporarily store at least one portion (e.g. a portion or all) of the contact list retrieved from the mobile phone.

Please note that the implementation of the apparatus 100 may vary according to different embodiments, such as the embodiment shown in FIG. 1A or some variations thereof. For example, the apparatus 100 may comprise at least one portion (e.g. a portion or all) of the multimedia player. In a situation where the apparatus 100 comprises a portion of the multimedia player, the control circuit 110 can be the control circuit of the multimedia player, such as an integrated circuit (IC). In a situation where the apparatus 100 comprises the whole of the multimedia player, the apparatus 100 can be the multimedia player, or can be an audio/video reproducing system comprising the multimedia player.

In some embodiments, such as the embodiment shown in FIG. 1A or some variations thereof, the multimedia player mentioned above can be one of a digital video recorder (DVR) (which can be equipped with program receiving functionality, for example), an optical disc player, a set top box (STB), a television (TV), and a TV receiver, or can be a combination of a DVR, an optical disc player, an STB, a TV, and/or a TV receiver. According to one of these embodiments, such as that shown in FIG. 1B, the multimedia player can be a TV 100-1 comprising a screen 150 (e.g. a liquid crystal display (LCD) panel) for displaying images of a program, where the apparatus 100 may comprise at least one portion (e.g. a portion or all) of the TV 100-1. According to another of these embodiments, such as that shown in FIG. 1C, the multimedia player can be an STB 100-2, which is typically electronically connected to a monitor 100M, where the apparatus 100 may comprise at least one portion (e.g. a portion or all) of the STB 100-2. For example, the monitor 100M comprises the screen 150 (e.g. an LCD panel) arranged to display images of a program, and more particularly, the images carried by at least one signal sent from the STB 100-2.

FIG. 1D illustrates an exemplary mobile phone 52 whose message input/output can be controlled through the apparatus 100 shown in FIG. 1A according to an embodiment of the present invention. For better comprehension, the STB 100-2 shown in FIG. 1C is taken as an example of the multimedia player of this embodiment. This is for illustrative purposes only, and is not meant to be a limitation of the present invention. According to some variations of this embodiment, other kinds of electronic devices (e.g. the TV 100-1 shown in FIG. 1B) can be taken as examples of the multimedia player of these variations.

As shown in FIG. 1D, the mobile phone 52 can be associated to the multimedia player such as the STB 100-2 through wireless communication, where the apparatus 100 (which may comprise at least one portion (e.g. a portion or all) of the STB 100-2) can communicate with the mobile phone 52 by utilizing communication device 140. More particularly, by utilizing the communication device 140, the detection module 112 can detect whether the mobile phone 52 associated to the STB 100-2 sends the information mentioned above, and more particularly, the information indicating the existence of the aforementioned at least one incoming message. In addition, when it is detected that the mobile phone 52 sends the information indicating the existence of the aforementioned at least one incoming message, the processing module 114 triggers the multimedia player such as the STB 100-2 to provide the user with the user interface, allowing the user to read or reply to the incoming message through the multimedia player such as the STB 100-2. As a result, the user can utilize the multimedia player to read or reply to one or more messages in time, having no need to find the mobile phone 52 or leave a comfortable environment.

According to this embodiment, the information indicating the existence of the aforementioned at least one incoming message can be indication information, rather than information of the aforementioned at least one incoming message itself. For example, the indication information may represent a summary regarding the aforementioned at least one incoming message. In another example, the indication information may represent a notification without any detail regarding the aforementioned at least one incoming message. This is for illustrative purposes only, and is not meant to be a limitation of the present invention. According to some variations of this embodiment, the information indicating the existence of the aforementioned at least one incoming message can be the information of the aforementioned at least one incoming message itself.

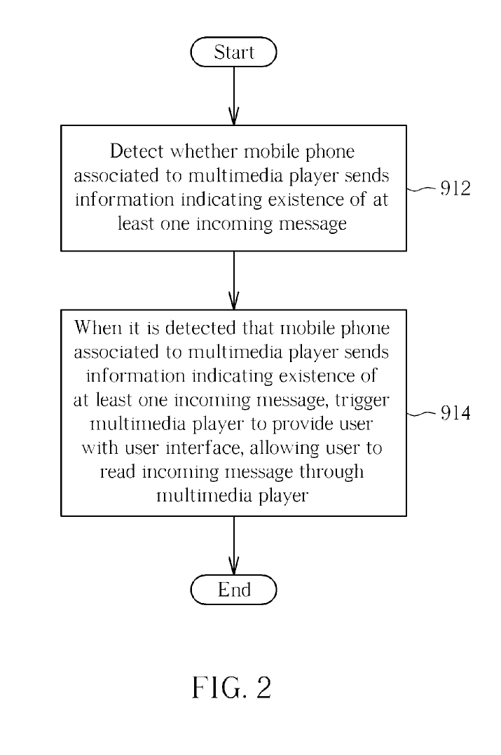

FIG. 2 is a flowchart of a method 910 for performing message control (e.g. message control regarding reading messages and/or replying to messages) through a multimedia player according to an embodiment of the present invention. The method 910 shown in FIG. 2 can be applied to the apparatus 100 shown in FIG. 1A. The method is described as follows.

In Step 912, the detection module 112 detects whether a mobile phone associated to the multimedia player, such as the mobile phone 52 shown in FIG. 1D, sends information indicating existence of at least one incoming message such as that mentioned above (e.g. one or more messages provided through SMS). For example, by utilizing an infrared (IR) communication device within the communication device 140, the detection module 112 can detect whether the mobile phone 52 associated to the multimedia player sends the information indicating the existence of the aforementioned at least one incoming message. In another example, by utilizing a Bluetooth (BT) communication device within the communication device 140, the detection module 112 can detect whether the mobile phone 52 associated to the multimedia player sends the information indicating the existence of the aforementioned at least one incoming message. In another example, by utilizing an IEEE 802.11g communication device within the communication device 140 (e.g. a Wireless Fidelity (Wi-Fi) communication device), the detection module 112 can detect whether the mobile phone 52 associated to the multimedia player sends the information indicating the existence of the aforementioned at least one incoming message.

In Step 914, when it is detected that the mobile phone associated to the multimedia player (e.g. the mobile phone 52) sends the information indicating the existence of the aforementioned at least one incoming message, the processing module 114 triggers the multimedia player to provide the user with the user interface, allowing the user to read the incoming message through the multimedia player. More particularly, when it is detected that the mobile phone associated to the multimedia player (e.g. the mobile phone 52) sends the information indicating the existence of the aforementioned at least one incoming message, the processing module 114 triggers the multimedia player to provide the user with the user interface, allowing the user to reply to the incoming message through the multimedia player.

In practice, the user interface mentioned in Step 914 may comprise at least one button hint (e.g. one or more button hints) indicating meanings of one or more buttons of a remote controller of the multimedia player. In addition to the aforementioned at least one button hint, the user interface mentioned in Step 914 may further comprise other information regarding message control (e.g. message control regarding reading messages and/or replying to messages). In a situation where the aforementioned at least one button hint is utilized as the OSD information mentioned above, the processing module 114 may trigger the multimedia player to perform OSD operations to mix the button hint into the video content to be displayed. As a result, the user may read the button hint and realize which button he/she may press based upon the button hint, and then press one or more buttons of the remote controller to control the subsequent operations of the multimedia player. For example, the button hint may comprise a string “Press [OK] to read”, and the user may press a button labeled/named “OK” to read the incoming message. This is for illustrative purposes only, and is not meant to be a limitation of the present invention. According to some variations of this embodiment, the user interface mentioned in Step 914 may comprise at least one virtual button (e.g. one or more virtual buttons) to be displayed on a screen such as the screen 150 mentioned in any of the embodiments respectively shown in FIG. 1B and FIG. 1C, for being selected by the user. In a situation where the aforementioned at least one virtual button is utilized as the OSD information mentioned above, the processing module 114 may trigger the multimedia player to perform OSD operations to mix one or more virtual button images (e.g. one or more partial images representing the aforementioned at least one virtual button) into the video content to be displayed. As a result, the user may realize which virtual button he/she may select (or “press”) based upon the meaning indicated by the virtual button images, and then select (or “press”) one or more virtual buttons displayed on the screen to control the subsequent operations of the multimedia player.

According to an embodiment, such as the embodiment shown in FIG. 2 or a variation thereof, when it is detected that the mobile phone associated to the multimedia player sends the information indicating the existence of the aforementioned at least one incoming message, the processing module 114 can trigger the multimedia player to provide the user with the user interface, allowing the user to reply to the incoming message with a multimedia message (which may comprise an audio message, a video clip, and/or a photo) through the multimedia player. For example, in a situation where the aforementioned at least one button hint is utilized as the OSD information mentioned above, the button hint may notify the user of which button he/she may press for replying to the incoming message with the multimedia message through the multimedia player. When the user presses this button, the user may say something in reply to the incoming message, and the processing module 114 records/generates the multimedia message by utilizing at least one accessory of the multimedia player, such as a microphone and/or a camera module. This is for illustrative purposes only, and is not meant to be a limitation of the present invention. According to some variations of this embodiment, in a situation where the aforementioned at least one virtual button is utilized as the OSD information mentioned above, the virtual button images mentioned above may notify the user of which virtual button he/she may select (or “press”) for replying to the incoming message with the multimedia message through the multimedia player. When the user selects (or “presses”) this virtual button, the user may say something in reply to the incoming message, and the processing module 114 records/generates the multimedia message by utilizing at least one accessory of the multimedia player, such as a microphone and/or a camera module.

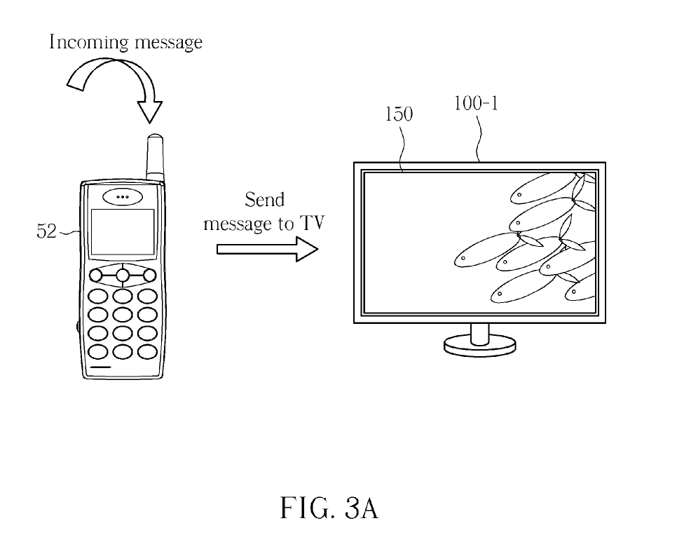

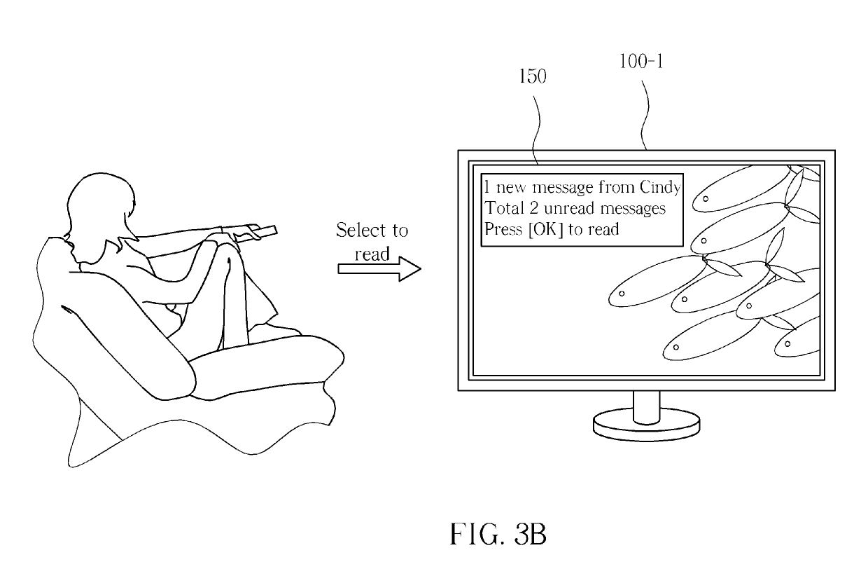

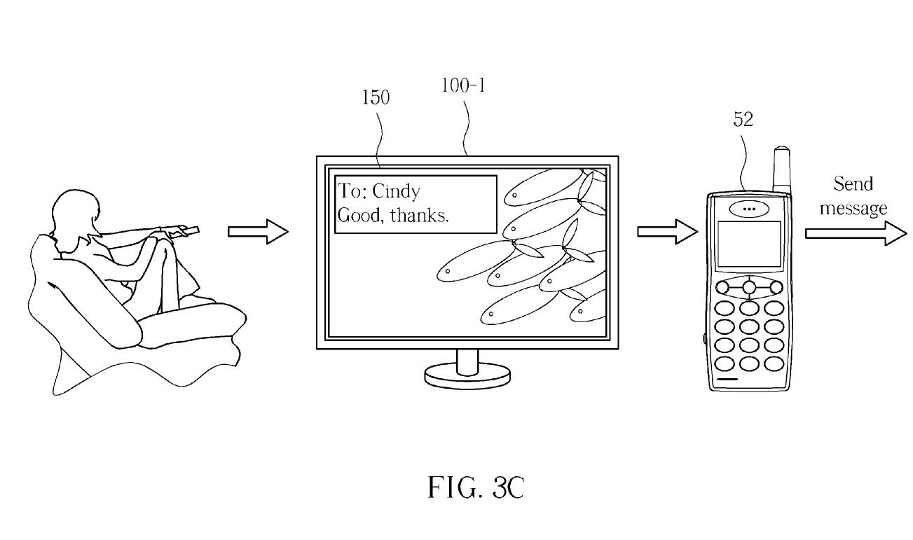

FIGS. 3A-3C respectively illustrate some implementation details involved with the method 910 shown in FIG. 2 according to an embodiment of the present invention. For better comprehension, the TV 100-1 shown in FIG. 1B can be taken as an example of the multimedia player mentioned in Step 912. This is for illustrative purposes only, and is not meant to be a limitation of the present invention. According to some variations of this embodiment, another electronic device such as the STB 100-2 shown in FIG. 1C can be taken as an example of the multimedia player mentioned in Step 912.

Referring to FIG. 3A, when the mobile phone 52 receives the incoming message, the mobile phone 52 may send a message such as an intermediate message to the TV 100-1. In this embodiment, the intermediate message can be the incoming message itself or an indication message carrying the indication information mentioned above. For example, in a situation where the intermediate message is the incoming message itself, the processing module 114 receives/retrieves the incoming message from the mobile phone 52 by utilizing at least one communication device of TV 100-1, such as the communication device 140 shown in FIG. 1A, for being read by the user based upon user selection. In another example, in a situation where the intermediate message is the indication message carrying the indication information mentioned above, the processing module 114 may wait for user selection, and after the user utilizes the user interface to select reading the incoming message, the processing module 114 retrieves the incoming message from the mobile phone 52 by utilizing at least one communication device of TV 100-1, such as the communication device 140 shown in FIG. 1A.

Referring to FIG. 3B, no matter whether the intermediate message is the incoming message itself or the indication message carrying the indication information mentioned above, the user interface in Step 914 may comprise a button hint such as the string “Press [OK] to read”, and may further comprise the aforementioned other information regarding message control, such as a string “1 new message from Cindy” indicating there is one new message from Cindy and another string “Total 2 unread messages” indicating there are two unread messages in total. These strings may be displayed on the screen 150 of the TV 100-1. After reading these strings, the user (shown in the left half of FIG. 3B) may press the button labeled/named “OK” (e.g. a button of the remote controller of the TV 100-1) to read the incoming message.

According to this embodiment, the processing module 114 may trigger the multimedia player such as the TV 100-1 to provide the user with the user interface, allowing the user to read or reply to the incoming message through the multimedia player such as the TV 100-1. Referring to FIG. 3C, in a situation where the user (shown in the leftmost of FIG. 3C) utilizes the user interface to select replying to the incoming message, the processing module 114 may provide the user with the user interface for inputting a message of the user, and the aforementioned other information regarding message control may comprise a string “To: Cindy” indicating that the apparatus 100 is performing the operation of inputting the message of the user. For example, the user may utilize the user interface to input a string “Good, thanks”, and the screen 150 of the TV 100-1 displays the string “Good, thanks” below the string “To: Cindy” to indicate the latest content of the message of the user, where the user may edit this message by utilizing the user interface. After completing the operation of inputting the message of the user, the processing module 114 can send the message of the user from the multimedia player such as the TV 100-1 to the mobile phone 52 by utilizing at least one communication device of TV 100-1, such as the communication device 140 shown in FIG. 1A. After receiving the message of the user, the mobile phone 52 can send this message to a mobile phone of the person who sends the incoming message mentioned in Step 912 (e.g. Cindy in this embodiment) within a telecommunication network. Thus, the present invention can serve the user well. As a result of applying the method of the embodiment shown in FIG. 2, the user can utilize the multimedia player such as the TV 100-1 to read or reply to one or more messages in time, having no need to go finding his/her mobile phone or leave the soft sofa.

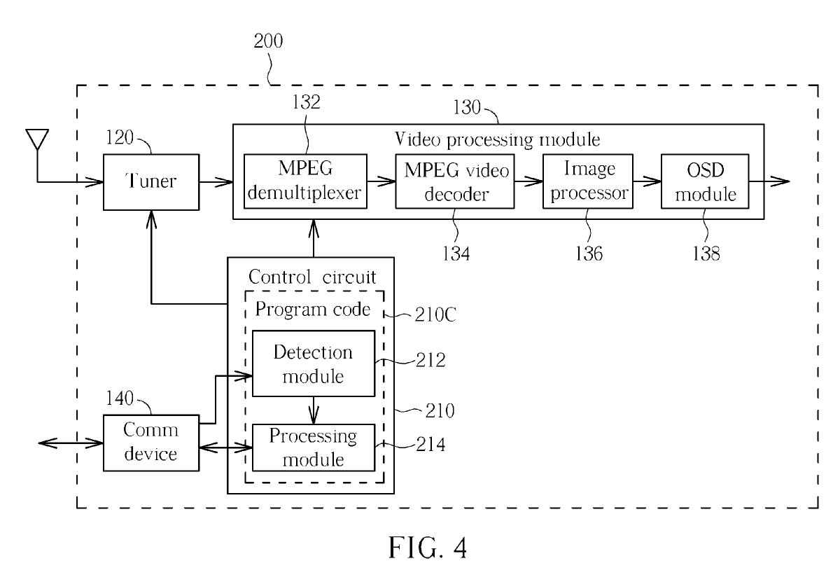

FIG. 4 is a diagram of an apparatus 200 for performing message control through a multimedia player according to a second embodiment of the present invention. According to this embodiment, the control circuit mentioned above can be implemented by utilizing a processing circuit executing a program code 210C, and therefore, can be labeled with another numeral 210 in response to the change in architecture, where the apparatus mentioned above can be labeled with the numeral 200 in response to the change in architecture. In addition, the program code 210C may comprise at least one program module, such as a detection module 212 and a processing module 214, where the control circuit 210 executing the detection module 212 can perform operations that are the same as or similar to those of the detection module 112, and the control circuit 210 executing the processing module 214 can perform operations that are the same as or similar to those of the processing module 114. Similar descriptions are not repeated for this embodiment.

It is an advantage of the present invention that the present invention method and apparatus can server the user well. In addition, the user can utilize the multimedia player to read or reply to one or more messages in time, having no need to find his/her mobile phone or leave a comfortable environment (e.g. an environment surrounded by family, with a soft sofa in an air conditioned room).

Those skilled in the art will readily observe that numerous modifications and alterations of the device and method may be made while retaining the teachings of the invention.

1. A method for performing message control through a multimedia player, the method comprising:
detecting whether a mobile phone associated to the multimedia player sends information indicating existence of at least one incoming message; and
when it is detected that the mobile phone associated to the multimedia player sends the information indicating the existence of the at least one incoming message, triggering the multimedia player to provide a user with a user interface, allowing the user to read the incoming message through the multimedia player.

2. The method of claim 1, wherein the step of detecting whether the mobile phone associated to the multimedia player sends the information indicating the existence of the at least one incoming message further comprises:
by utilizing at least one communication device of the multimedia player, detecting whether the mobile phone associated to the multimedia player sends the information indicating the existence of the at least one incoming message.

3. The method of claim 2, wherein the step of detecting whether the mobile phone associated to the multimedia player sends the information indicating the existence of the at least one incoming message further comprises:
by utilizing an infrared (IR) communication device within the at least one communication device, detecting whether the mobile phone associated to the multimedia player sends the information indicating the existence of the at least one incoming message.

4. The method of claim 2, wherein the step of detecting whether the mobile phone associated to the multimedia player sends the information indicating the existence of the at least one incoming message further comprises:
by utilizing a Bluetooth (BT) communication device within the at least one communication device, detecting whether the mobile phone associated to the multimedia player sends the information indicating the existence of the at least one incoming message.

5. The method of claim 2, wherein the step of detecting whether the mobile phone associated to the multimedia player sends the information indicating the existence of the at least one incoming message further comprises:
by utilizing an IEEE 802.11g communication device within the at least one communication device, detecting whether the mobile phone associated to the multimedia player sends the information indicating the existence of the at least one incoming message.

6. The method of claim 1, wherein the information indicating the existence of the at least one incoming message is information of the at least one incoming message itself.

7. The method of claim 1, wherein the step of triggering the multimedia player to provide the user with the user interface further comprises:
when it is detected that the mobile phone associated to the multimedia player sends the information indicating the existence of the at least one incoming message, triggering the multimedia player to provide the user with the user interface, allowing the user to reply to the incoming message through the multimedia player.

8. The method of claim 7, wherein the step of triggering the multimedia player to provide the user with the user interface further comprises:
when it is detected that the mobile phone associated to the multimedia player sends the information indicating the existence of the at least one incoming message, triggering the multimedia player to provide the user with the user interface, allowing the user to reply to the incoming message with a multimedia message through the multimedia player.

9. The method of claim 8, further comprising:
recording/generating the multimedia message by utilizing at least one accessory of the multimedia player.

10. The method of claim 1, wherein the user interface comprises at least one button hint indicating meanings of one or more buttons of a remote controller of the multimedia player.

11. The method of claim 1, wherein the user interface comprises at least one virtual button to be displayed on a screen, for being selected by the user.

12. The method of claim 1, further comprising:
retrieving the incoming message from the mobile phone.

13. The method of claim 12, wherein the step of retrieving the incoming message from the mobile phone further comprises:
retrieving the incoming message from the mobile phone by utilizing at least one communication device of the multimedia player.

14. The method of claim 1, further comprising:
sending a message of the user from the multimedia player to the mobile phone.

15. The method of claim 14, wherein the step of sending the message of the user from the multimedia player to the mobile phone further comprises:
sending the message of the user from the multimedia player to the mobile phone by utilizing at least one communication device of the multimedia player.

16. An apparatus for performing message control through a multimedia player, the apparatus comprising:
a control circuit arranged to control operations of the multimedia player, wherein the processing circuit comprises:
a detection module arranged to detect whether a mobile phone associated to the multimedia player sends information indicating existence of at least one incoming message; and
a processing module, wherein when it is detected that the mobile phone associated to the multimedia player sends the information indicating the existence of the at least one incoming message, the processing module triggers the multimedia player to provide a user with a user interface, allowing the user to read the incoming message through the multimedia player.

17. The apparatus of claim 16, wherein by utilizing at least one communication device of the multimedia player, the detection module detects whether the mobile phone associated to the multimedia player sends the information indicating the existence of the at least one incoming message.

18. The apparatus of claim 16, wherein when it is detected that the mobile phone associated to the multimedia player sends the information indicating the existence of the at least one incoming message, the processing module triggers the multimedia player to provide the user with the user interface, allowing the user to reply to the incoming message through the multimedia player.

19. The apparatus of claim 16, wherein the apparatus comprises at least one portion of the multimedia player.

20. The apparatus of claim 16, wherein the multimedia player is one or a combination of a digital video recorder (DVR), an optical disc player, a set top box (STB), a television (TV), and/or a TV receiver.
